(19) United States
(12) Patent Application Publication
(10) Pub. No.: US 2002/0147608 A1
(43) Pub. Date: Oct. 10, 2002

(54) Method of generating and supervising marketing and sales business communications

(76) Inventor: Henry Ira Carpenter, Berwyn, PA (US)

Correspondence Address: PEPPER HAMILTON LLP, 50th Floor, One Mellon Center, Pittsburgh, PA, 15219, US

(21) Appl. No.: 10/082,549

(22) Filed: Feb. 25, 2002

Related U.S. Application Data
(60) Provisional application No. 60/272,292, filed on Feb. 28, 2001.

(51) Int. Cl. G06F 17/60

(52) U.S. Cl. 705/1

(57) ABSTRACT

A method for generating business and other communications for dispersed users such as marketing or sales agents by inputting communication content and special processing instructions to a repository, providing supervisors access to the communication content and special processing instructions for review and edit of the same, providing dispersed users access to said communication content and special processing instructions and enabling the dispersed users to select a portion of the communication content and special processing instructions for generating said communications. Templates may be provided in the repository containing layout instructions for the communications.

### PRIORITY

This application claims priority to the United States Provisional Patent Application entitled “Method of Generating and Supervising Marketing and Sales Business Communications,” filed Feb. 28, 2001, serial No. 60/272,292, which is incorporated herein by reference in its entirety.

### FIELD OF THE INVENTION

The present invention relates generally to business and entertainment communications such as product and services marketing and sales. In particular, the present invention relates to using computer based information and document generation systems to supervise and control the manner and content of communications between sales and marketing managers, agents and their customers.

### BACKGROUND OF THE INVENTION

The sale and marketing of some types of goods often requires a business to employ a large group of salespersons or marketing personnel to individually contact potential purchase decision makers. These purchase decision makers are usually the customers themselves or the customer's agents, but may also be intermediary decision makers, such as retailers or distributors. For example, pharmaceutical companies employ a specialized marketing group known as “detail men” to distribute product information, marketing materials and samples to physicians in order to fully inform the physician's decision on which drugs to select and prescribe for their patients. Although the physician's patients are the drug's actual purchasers, the physician's decision to select and prescribe the drug often determines whether or not the drug is purchased and used. It is believed that this selection is based both on the physician's training and background, and the information contained in the Physician Desk Reference and package insert, but may also be significantly influenced by the relationship between the physician and a particular detail man, and the communications the physician receives from the aforementioned detail men, at least in the situations where the physician has a plurality of drugs to select from to treat their patient. In these situations, the drugs may have substantially similar medicinal value and uses in treatment, but differ in their side effects, indicators, or cost. The relationship and communications between the detail men and physician are often of high importance in generating sales revenue for pharmaceutical companies.

Another example of this type of communications is in the field of retail food distribution. Producers/distributors employ field representatives to place their products in the stream of commerce in various outlets, such as grocery, drug, and convenience stores. These products may include packaged goods, prepackaged foods, produce, and other products. Even if a store decides to carry a product or line of products, the manner in which these products are displayed and advertised within the store is believed to affect the consumer's purchase choice. Thus, the field sales and marketing representatives attempt to educate and persuade retailers regarding product placement by sending the retailers communications (letters, faxes, electronic mail, etc.) containing marketing information designed to persuade the retailers to favorably display the producer's products, or, when an agreement exists regarding product placement, to remind them of this agreement.

However, the companies which distribute marketing information in this fashion often require a high level of control over the content of the materials distributed. As this information may materially relate to the sales transaction, companies often attempt to supervise and control the information distributed by their sales force, and dictate the manner in which they are distributed and the type of materials distributed. Inconsistent distribution of information is avoided in this manner. In the pharmaceutical industry, since the marketing information may be regulated and may be used in part by a physician to make a decision to prescribe a course of treatment or medication, closer supervision of the information distributed and a higher level of control of the marketing sales force is also deemed to be necessary. However, implementing an effective level of control can become a logistical problem when the marketing or sales force is large or geographically dispersed, regionally or nationally. Current methods of supervision can be labor intensive, requiring supervisory personnel to review individual communications after the communication is generated, either before it is sent to the sales decision maker.

At the same time, the sales and marketing agents require a degree of freedom to exercise their discretion and initiative in distributing the information in order to build relationships and promote sales. Other, fully automated specialized systems fail to generate individualized communications, and lack mechanisms for feedback communication between the representative and management.

Thus a need exists for a method of implementing effective and more efficient control and supervision over the information and materials distributed by a dispersed marketing workforce that allows a company to exercise central control without substantially impeding the workforce's access to this information and materials.

### SUMMARY OF THE INVENTION

The present invention relates to a method for generating business communications for dispersed marketing agents by inputting the content of the communication to be in a central or distributed repository, providing supervisors access to the content, and providing the marketing agents access to the content to effect distribution. Also, by separating the creation of the element of communication (Content, Templates, Special Processing Instructions) from the generation of the communication, resources can be more efficiently used for generating each of the elements. This results in business communications that are higher in quality and generated in a more efficient and cost-effective manner.

In one embodiment of the invention, the central repository is a database stored in a computer with a memory storage device, and the method includes providing access to the central database from a supervisory workstation in electronic communication with the central repository, inputting content, reviewing the content stored therein prior to distribution to the sales and marketing agents, and providing access to said sales information to sales and marketing agents in electronic communication with said central repository.

In one embodiment of the invention, the method includes selecting a portion of said marketing content from said database, inserting said marketing content into a document Template, and generating a document separately stored in-part or whole in an electronic memory storage device. Also, the content input by the supervisor and accessed by the agents includes communications, composed Templates and Special Processing Instructions for composition and distribution. The document can be rendered at the central location, the marketing agent's workstation, or the customer's workstation. Such document rendering may include, but is not limited to, the document being printed at a printer operably linked to a computer, displayed on a computer monitor operably linked to a computer, or transmitted electronically via an electronic mail protocol or facsimile transmission. In one embodiment of the invention, the document is a web page and the rendering is performed at least in part by a web browser computer program such as MS Explorer or Netscape Communicator, running on the marketing agent or customer's workstation. As used herein, a workstation includes a personal computer operably connected to a monitor, input devices such as keyboard, computer mouse/touchpad/pointer, printer, and, optionally, to a Local Area Network (LAN), intranet or internet of workstations.

In one embodiment of the invention, after rendering, the document can be stored in hard copy or digital format. Optionally, the document is stored in digital format at the central repository, at the marketing agent's station, or at both locations.

### BRIEF DESCRIPTION OF THE DRAWINGS

FIG. 1 depicts a flow diagram of one embodiment of the method for controlling sales communications.

FIG. 2 depicts a web page communication generated by the method of the invention, where the web page is generated by the program from marketing content in the database, layout Templates in the database, content input by the user, and Special Processing Instructions.

FIG. 3 depicts a security table contained within the database, and accessed by the program.

FIG. 4 depicts a Content Area table contained within the database, and accessed by the program.

FIG. 5 depicts a reference table contained within the database, and accessed by the program.

FIG. 6 depicts a user desktops table contained within the database, and accessed by the program.

FIG. 7 depicts a Template table contained within the database, and accessed by the program.

FIG. 8 depicts a Special Processing Instructions file accessed by the program.

FIG. 9 depicts a Special Processing Instruction file accessed by the program.

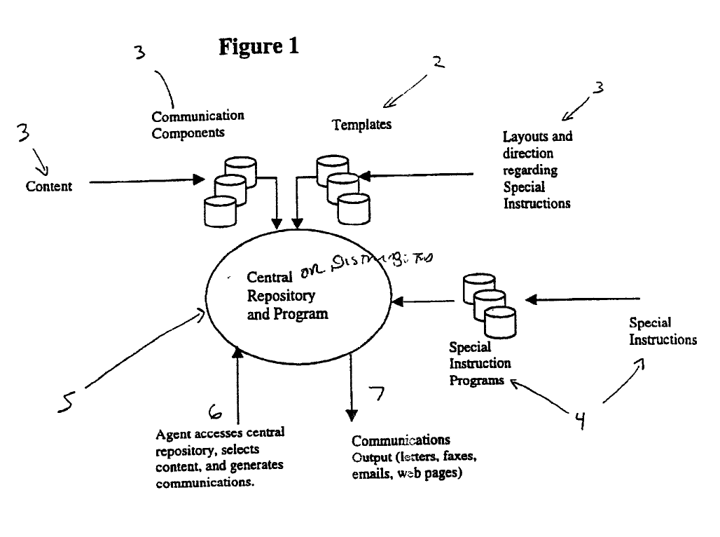

### DETAILED DESCRIPTION OF PREFERRED EMBODIMENTS OF THE INVENTION

The following terms are used in the application, and are presented herein to provide clarity and guidance, and are generally within the ordinary or usual technical meaning of the word unless otherwise indicated. A communication component is defined as an individual data file, and may include voice, text, web page (e.g. HTML, XML, DHTML, etc.), video, graphics, sound, fax, email or other electronic files. These individual data files are typically used to inform or influence decision makers or consumers regarding a company's product or services. A communication message is defined as a series of communication components delivered and received in a specified communication medium, such as an electronic or postal mail, fax, web page display, or broadcast, and a communication output or message (or output message) is defined as a communication message generated by the method of the invention. A typical communication message can be a business communication or web page document. Exemplary web page languages and formats may include, but are not limited to, HTML, XML, DHTML, and Flash. Exemplary business communications formats include, but are not limited to reports, faxes, electronic mail, postal mail, video, music or sound scripts, or application documents such as WORD or EXCEL.

Special Processing Instructions are defined as instructions regarding gathering, manipulating, and storing of the communication component that makes up the output message.

Layout Instructions are defined as the instructions that specify the location and identity of components, their appearance, location and sequence of use/rendering, the medium for delivery of the output message (print, email, mail, fax, Web, voice, etc.), and Special Processing Instructions required to render the message output. A Template is defined as a database record (regardless of format) that contains layout instructions. Exemplary database formats may include, but are not limited to, ACCESS, EXCEL, LOTUS or FOXPRO, SQL Server, Oracle, flat files, Sybase, or Informix. Users are typically a small group of supervisory users or content providers, who input components for others to use in generating the output messages, and a much larger group of dispersed users, such as marketing or sales agents and field representatives, who can readily access those components to generate business communications and submit feedback in the form of suggested additions or revisions to the content. Optionally, the supervisory users and/or the dispersed users comprise individuals, groups, intelligent machines, or any combination thereof.

To implement an embodiment of the method, a supervisory user inputs a Template 2 for each type of communication message desired, along with individual communication 3 components (data files) that can be selected and inserted into the Template. The supervisory user creates programs for enabling the Special Processing Instructions 4, i.e., instructions for storing the communication components. Typically, these programs, Template and data files are stored in a repository 5, and are accessed and protected by a password or security protocol. The repository is typically a computer memory device such as a hard drive, operably connected to a programmed central processor, and thereby to random access memory, input devices such as scanners, keyboards, or mouse, output devices such as a display monitor or printer, and, optionally, via a cable, modem or network link to separate computer workstations. The term repository as used herein is intended to include a central repository, a distributed repository and a central and distributed repository The program receives instructions from users 6 and implements those instructions to create business communications output by retrieving the appropriate component(s), Template (with Special Processing Instructions) from the memory device, and applying the components to the Template. The Template's Special Processing Instructions direct the component to the appropriate location and/or sequence in the communication, and the output is generated and saved as a separate file or remain in transient form, as is the case with a dynamic web page, sound communication, or video file format. Again, these business communications can include, but are not limited to e-mails, faxes, letters or web pages.

Alternatively, or in combination with the aforementioned exemplary system, the Templates contain text representing the content that will be output to the appropriate medium as instructed by the program. The text can also include references to data that will be merged in, where it should be merged in, and any special processing that should be done to the data prior to merging it in. The text can also contain other instructions which will be interpreted by the program, and executed either as part of the program core instructions or as instructions that are external to the program, but which the program can locate and recall. These instructions can be in any computer programming language, including, but not limited to HTML, XML, DHTML, C++, Visual Basic, SQL, Fortran, or JAVA, and are independent of the Template used and the type of output desired. Alternatively, the instructions can be carried out by computer applications with embedded programs, including, but not limited to EXCEL® and LOTUS®. The language or application selected depends on the type of processing required, as well as considerations of performance, efficiency and ease-of-use. When the user accesses the program and selects the content desired, the program reads the appropriate Template, merges the appropriate data, and performs the appropriate special processing as directed by the Template/Special Processing Instructions.

Typically, Templates 2 can be of any type of data file including, but not limited to, flat files, Access, SQL Server, Oracle, Sybase, dBase, DB2, or Informix. It is recognized that other file formats may also be used, depending on the type of output message desired. Also, it is believed that the individual components can be stored in any format including digital, analog, or paper copy as appropriate to the type of component, while Special Processing Instructions can be input and stored in the appropriate computer or machine program. To date, Template and component file formats have included flat files (fixed field length or delimited), Access files, SQL server files, EXCEL files, and Dbase files, and programming languages used have included Basic and Visual Basic, C, C++ Assembler, Clipper, Dbase, HTML, and Perl.

Prior to generating output, supervisory personnel input the following items which establish the content and Template framework that are later accessed by applications used by field and sales agents to generate marketing communications. The supervisor creates a database in the central repository and inputs the type and content of the components, Templates and Special Processing Instructions, that field personnel will be allowed to use, such as letters, fax, email, video, web pages, including the available types of look-and-feel desired for the messages. Although an ACCESS database was used in the following examples, it is recognized that other types of databases can be used without departing from the scope of the invention. The communication components, Template, and Special Processing Instructions are input and stored in the database as needed. All types of files are input and identifiably stored in the memory device, can be selected from a remote station in electronic communication with the central repository, and identify Special Processing Instructions that are needed to generate or store or route the communication. For example, these Special Processing Instructions are contained in the records in the “Templates” table described below and ancillary program files which can be retrieved and implemented by the program.

The dispersed users, such as field representatives or marketing agents, are then able to access the database via applications provided for this purpose. These agents then select the appropriate elements, which may include, but are not limited to, Template, and Special Processing Instructions, including layout instructions and content, and generate output for use as marketing communications. This is done in such a way as to require little or no knowledge of the inner workings of the database or program on the part of the agent beyond that necessary to access the central repository files, (i.e., log onto the database and select files) allowing the agent to focus his or her attention on improving the business relationship by personalizing the appropriate parts of the communications content or message. This also allows the companies which utilize this method to save on computer education and personnel expenses, as the company's agents need not devote company resources to developing substantial computer skills.

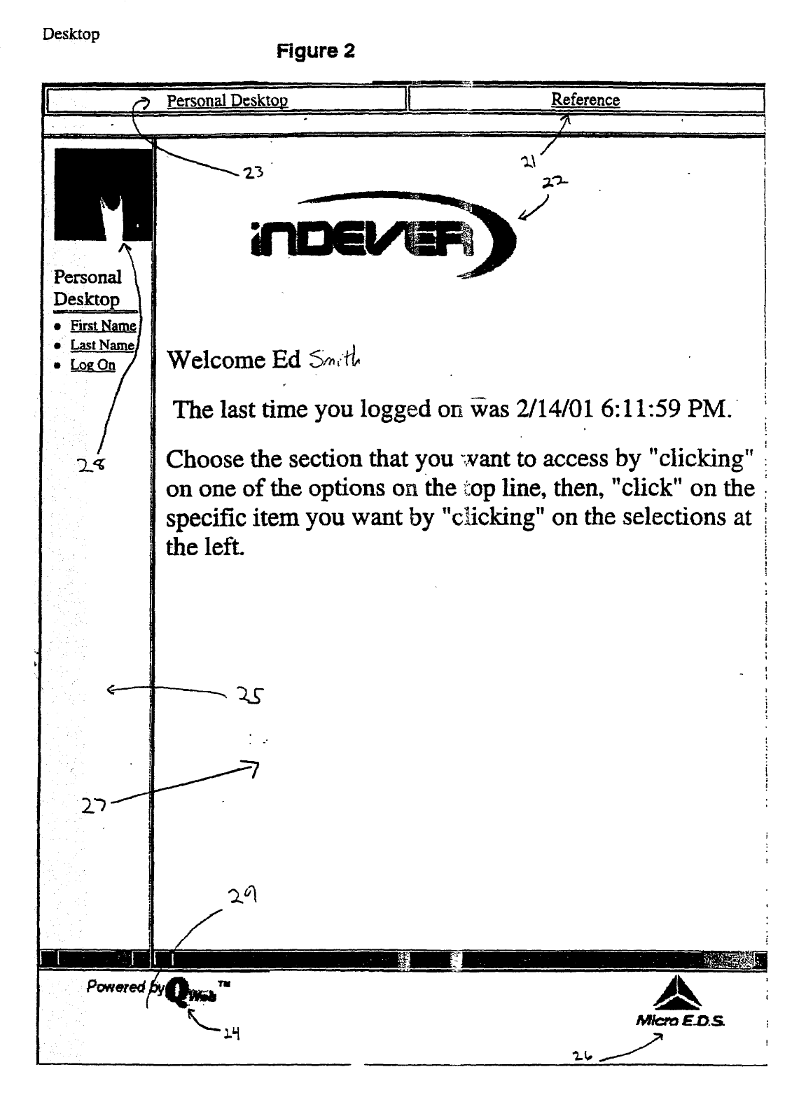

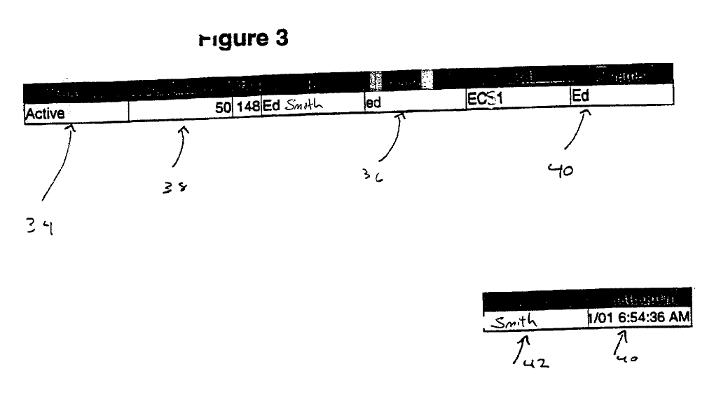

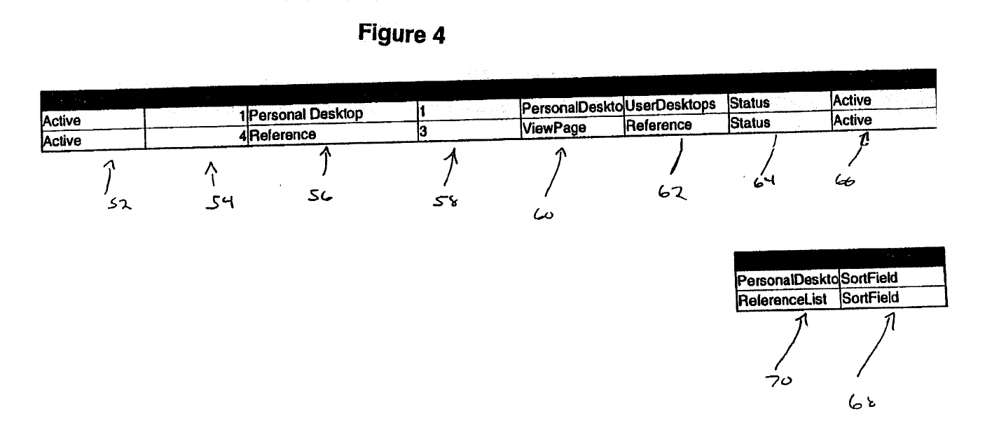

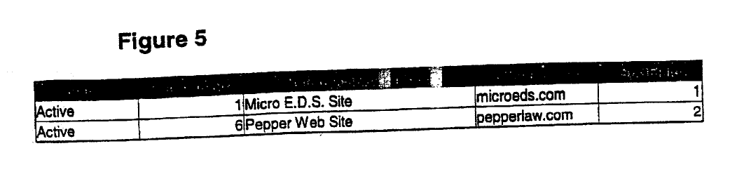

The content below was created and input for use in generating FIG. 2, a web page, using the method and program as described. It is recognized that communication components can be almost any files stored in digital format. The files created in this example include graphics files, sound files and database content. The graphics files include the Indever Logo 22 (filename and type=Indever.jpg), the Powered by QWeb™ Logo 24 (PoweredByQWeb.gif), and the small Micro E.D.S., Inc. Logo 26, (MEDSLogoTiny.gif). The Example also includes a picture file 28 for each user who has access to the private site (50.jpg). Not depicted is the sound file, welcome.mp3. Other types of files may include video files, text files or other appropriate data files.

In this example, an ACCESS MDB database was created and data tables were generated identifying the components, Templates and Special Processing Instruction programs. Although a single database was used for this example, it is recognized that the content and programs may be stored in separate databases as necessary. FIG. 3 depicts in part the database Qsecurity.mdb, which in the current example, contains an optional security table which determines if a user has access to the website generated. The fields of the Security table include: Status 34 (Determines if the record is active or not); ID (Specific User's ID for access to Desktop); Password 36 (Specific User's Password for access to Desktop); SecurityID 38 (Specific user's additional security identification for access to Desktop); Fname 40 (Specific user's first name); Lname 42 (Specific user's last name); LastLogOn 40 (date and time that the specific user logged onto the web page generated by the invention.

The content areas are entered and stored in a table that defines the menu items that will appear for all valid users in the horizontal menu at the top of the exemplar web page, and the content/application to access when the user selects a specific menu item from this horizontal menu. The two examples depicted are: Personal Desktop 23 (when the user selects this, he/she will receive a list of options available to him/her in the vertical menu); and Reference 21, (when the user selects this, they will see the list of reference options available to everyone in the vertical menu). The fields of the Desktop table include: Status 52 (Determines if the record is active or not); ContentAreaID 54 (Unique ID for that area of content); Content Description 56 (the description that will appear on the horizontal menu); SortOrder 58 (the order in which the content items will appear on the horizontal menu); Action 60 (the Special Processing Instructions to perform when this menu item is selected by the user); Table 62 (name of the table to use when performing the Action described above for a specific menu item); Field 64 (the name of the field to use as a criterion for selecting the records from the Table above, when the Action is performed); FieldValue 66 (the value that the Field must have in order to be included in the records from the Table); SortField 68 (the order in which to display the records that were selected from the Table based on their Field equaling the FieldValue); and QWebID 70 (the Template record to use when performing the Action).

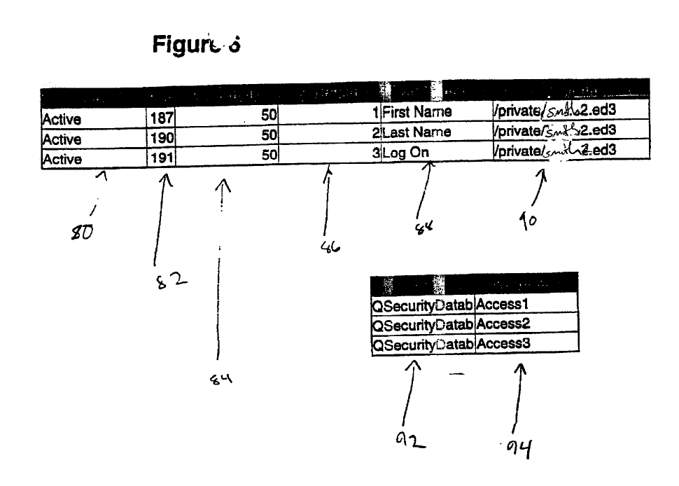

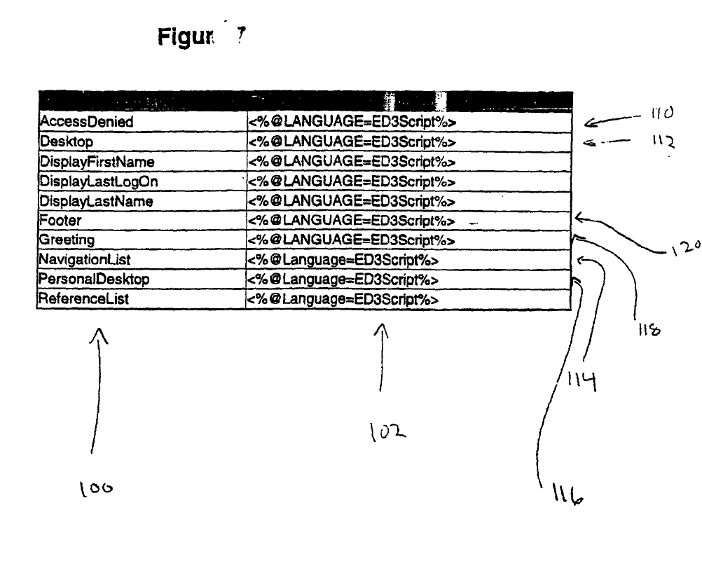

In this example, the values for the UserDesktops, FIG. 6, are entered and stored a table that defines the menu items that will appear in the vertical menu for the specific user based on their SecurityID gathered at login (defined above), and the content and Special Processing Instructions to be made accessible when the user selects a specific menu item. Also, in this example, the agent/user is given three menu items. The fields of the table include: Status 80 (determines if the record is active or not); RecordID 82 (unique identification for that record); SecurityID 84 (if a specific user has this SecurityID, then he/she will have access to this menu item); SortField 86 (specifies the order in which to display the menu items); Description 88 (the description that will appear on the vertical menu for that menu item); Program 90 (name and memory address of computer program(s) containing Special Processing Instructions to perform when that menu item is selected); QWD 92 (name of the database to access when a specific menu item is selected); and QwebAction 94 (Special Processing Instructions (in Program) to execute when a specific menu item is selected).

The Templates, as depicted in FIG. 7, are entered and stored in a Table whose records contain the text, identify communication components to include, define the way that the content should appear or be manipulated, and identify the Special Processing Instructions. In this example, the Templates define the appearance for each web page or section of a web page. The fields used in this example include TemplateID 100 (ID for the specific Template); Template (content instructions and Special Processing Instructions for the Template and the Template Records). In this example, the Template field contains HTML code that, in some cases, a Template also specifies Special Processing Instructions, which, in this example, are contained in .ed3 files.

The Template records shown in FIG. 7 include an AccessDenied record 110, which specifies the content and layout of the screen to present if the user enters an invalid user identification, password, or security identification. The Desktop record 112 specifies the layout for structure of Opening Screen. In FIG. 2, a four frame design was defined with VB Script and HTML. In this example, these frames include: a navigation frame 23 (horizontal menu at top of screen which displays the records from the ContentArea table as described above; an option frame 25 (the vertical menu at left side of screen, built by displaying the records that match the user's specific security identification); a Content frame 27 (the large frame at the lower right that displays the content based on the user's specific selection; and a Footer frame 29 (the frame at the bottom of the screen that displays the Powered by Qweb 24 and MicroEDS 26 logos).

In this example, each frame specifies Special Processing Instructions for populating the frame. The Navigation frame is populated by calling the Special Processing Instruction called “ViewPage” found in a Special Processing Instruction program file, QWeb2.ed3, and tells ViewPage to use the table called ContentAreas, selecting records where the field Status is equal to “Active,” sort them by the field in ContentArea called SortOrder.” A user's application generates this section of the page using the record called “NavigationList” 114 from FIG. 7.

The Option frame is populated by calling the Special Processing Instruction called PersonalDesktop 116 found in the Special Processing Instruction program file called “QWeb2.ed3.”

The Content frame is populated by calling the Special Processing Instruction called “Greeting” 118 found in the Special Processing Instruction program file called “QWeb2.ed3,” and tells “Greeting” to use the table called “Security,” selecting records where the field “Status” is equal to “Active,” and sort and display the records by the field “Status.” A user's application generates this section of the page using a record called “Greeting” from the FIG. 7, Template table.

The Footer frame is populated by calling the Special Processing Instruction called “ViewPage” found in the Special Processing Instruction program file called “QWeb2.ed3,” and tells “ViewPage” to use the table called “Dummy” (not depicted), selecting records where the field “Status” is equal to “A,” and sorts the records by the field “Status.” The user's application generates this section of the page using another record called “Footer” 120 from FIG. 7, Template table.

In this example, the Footer record specifies the text content, which external communication components to include in the footer, and the layout of the page to display in the “Footer” frame defined in the “Desktop” record above. The layout includes the HTML code that specifies the layout structure for the Footer Frame and the text for the frame. The content of this frame includes the communication components embedded in the frame, i.e., the Powered by Qweb Logo 24 and the small MicroEDS Logo 26.

Also, the Greeting record specifies the text content, which external communication components to include, and the layout of the page to display in the Content frame defined in the Desktop record above when the user first logs onto the system. This record also contains the HTML code that specifies the layout structure for the Greeting in the Content Frame, and the text for the Frame. The record also specifies the data to extract from the Security Table that is specific to the logged-in user, including their name and the date and time of their last login. As before, this record also identifies the communication components to embed into the Content Frame (the Powered by QWeb Logo 24 and Small MicroEDS 26 Logo, as well as a Greeting Sound File)

The NavigationList record 114 specifies content and layout for structure of Navigation menu (here, the horizontal menu). In the example, VB Script and HTML were used. This record also specifies the Special Processing Instructions to be executed when the user selects an option from the navigation menu. The record performs this function by calling from the external program QWeb.ed3, the Special Processing Instruction defined in the Action field of the Table defined in the Table field of the ContentArea Table, and selects the record who's field (as defined in the Field field) equals the FieldValue as defined in the FieldValue field. The program then generates the appropriate menu in the “Options” frame, using the Template that is defined in the QwebID field of the Table.

The “PersonalDesktop” record 116 specifies the content and layout for the structure of the Options menu. In this example, VB Script and HTML were used. This record specifies the layout structure for the Options Frame, the Special Processing Instructions for populating the Options Frame, identifies the communication components to embed into the Options Frame, including in this instance, the User's picture. The record also specifies Special Processing Instructions to be executed when the user selects an option from the Options menu by calling the Special Processing Instruction file defined in the “Program” field of the record associated with that menu item (in the example depicted, these records come from the UserDesktops table). The program then runs the routine defined in the “QwebAction” field of the record associated with that menu item, and passing to the routine the name of the database defined by the “QWD” field.

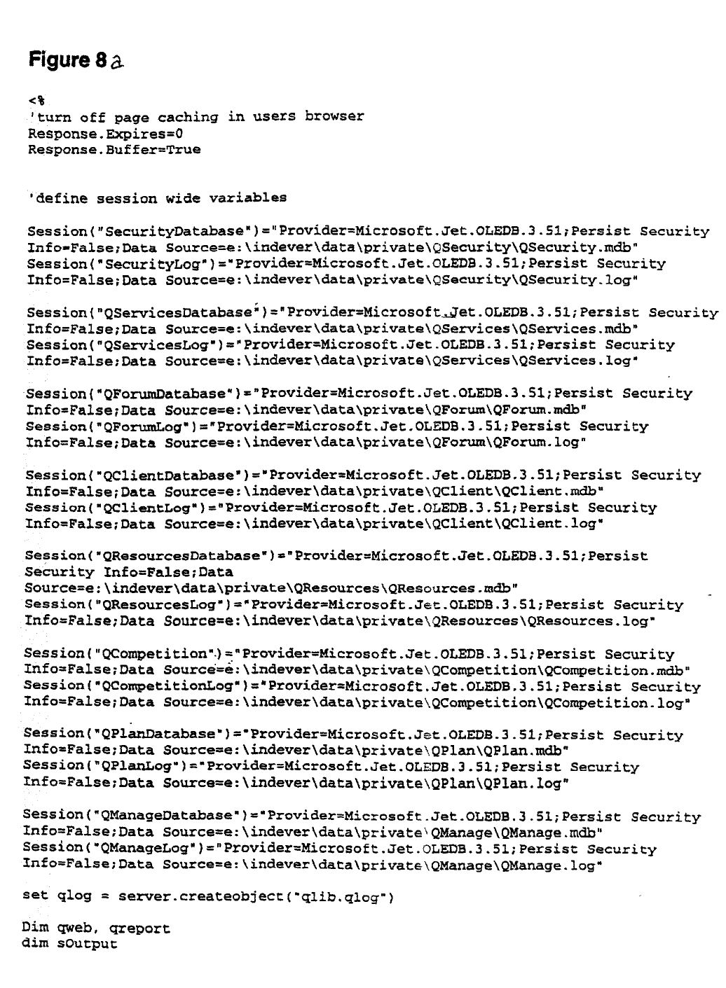

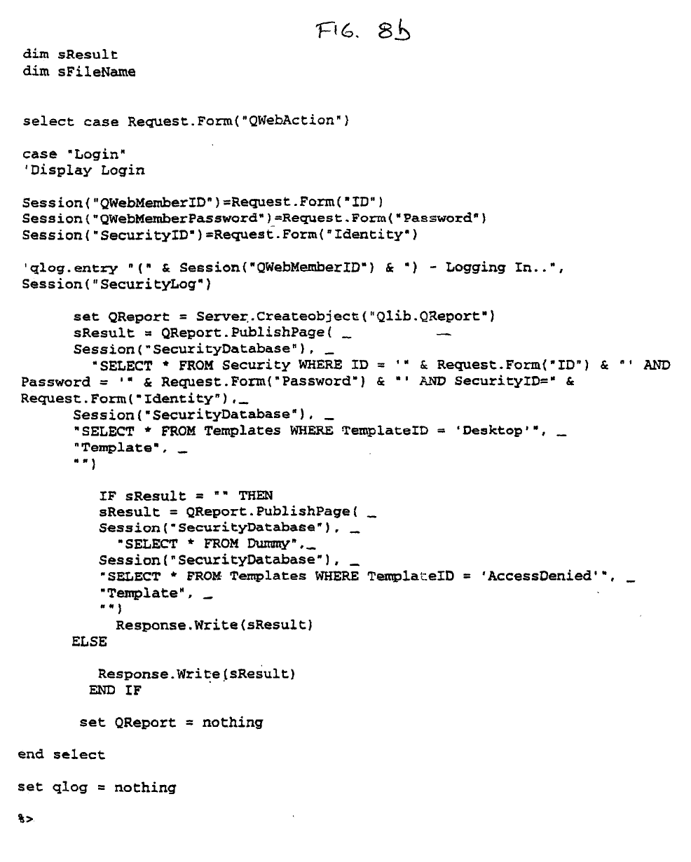

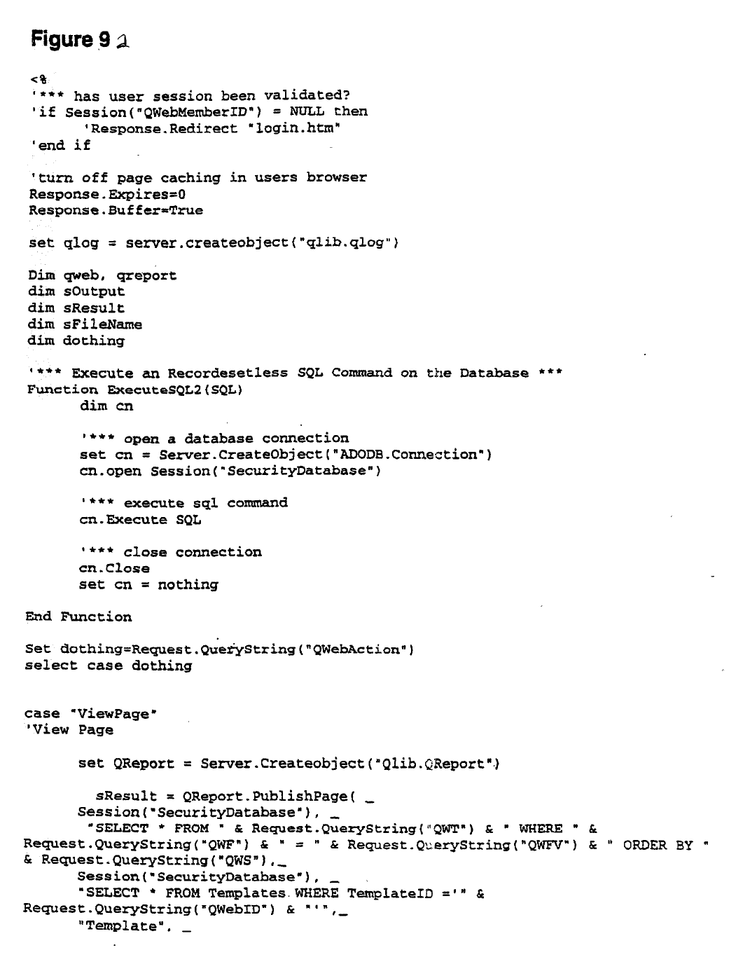

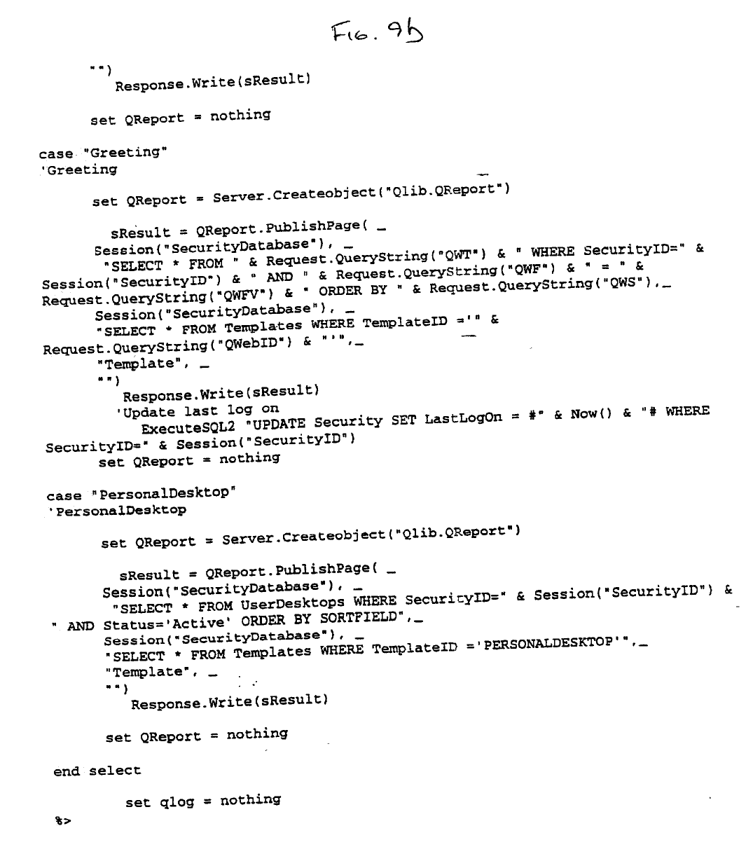

The above mentioned Special Processing Instruction files may be created by programmers, supervisors or users with appropriate security access in program files that are a part of, or separate from but accessibly located to, the program of the invention. These instructions may be defined by the company's supervisory users, and programmed in a machine or computer language which is readable by the database and its ancillary programs. FIG. 8 and FIG. 9 depict examples of Special Processing Instruction files which build and route the communications and reset the session variables.

The many features and advantages of the invention are apparent from the detailed specification, and thus, it is intended by the appended claims to cover all such features and advantages of the invention which fall within the spirit and scope of the invention. The foregoing description is intended to be illustrative of the invention, and is not intended to contain or imply limitations thereupon. Also, although numerous modifications and variations will readily occur to those skilled in the art, it is not desired to limit the invention to the exact method and operation illustrated and described, and accordingly, all suitable modifications and equivalents may be resorted to, falling within the scope of the invention described herein.

What is claimed is:

1. A method for generating business and other communications for dispersed users, comprising the steps of:
inputting content and special processing instructions into a repository;
providing access to said content and special processing instructions to at least one supervisor;
providing the dispersed users access to the content and special processing instructions; and
enabling the dispersed users to select a portion of said content and special processing instructions for generating said communications.

2. The method of generating business and other communications according to claim 1 wherein said inputting step further comprises inputting at least one template into said repository.

3. The method for generating business and other communications according to claim 1, wherein said repository comprises a processor operably connected to a memory storage device, an input device and an output device.

4. The method for generating business and other communications according to claim 2, wherein said step of inputting content, templates and special processing instructions further comprises the steps of establishing a database within said repository, and inputting said content and templates into said database.

5. The method for generating business and other communications according to claim 4, wherein said database includes a plurality of categories, said plurality of categories including selectable entries.

6. The method for generating business and other communications according to claim 1, wherein said marketing agents access the repository using remote computer workstations in electronic communication with said repository.

7. The method for generating business communications of claim 1, wherein said business and other communications are selected from the group consisting of web pages, electronic mail messages, and business letters.

8. A method for generating business and other communications for dispersed users, comprising the steps of:
establishing a database for storing content and templates within a repository;
inputting into said database content and templates;
providing access to said database to at least one supervisor, wherein said supervisor reviews and edits the content, templates and special processing instructions stored within said database;
providing remote access to said database to said dispersed users and enabling individual dispersed users to perform the step of selecting a portion of said content, templates and special processing instructions for generating said business and other communications,
wherein said special processing instructions are input and stored in said repository, or said database.

9. The method of generating business and other communications for dispersed users of claim 8, further comprising the step of rendering said communication with a web browser application.

10. The method of generating business and other communications for dispersed users of claim 8, wherein the individual dispersed user accesses the database using a remote computer workstation, including a central processor operably connected to an input device, an output device, a memory storage device and said remote computer workstation is in electronic communication with said central repository.

11. The method of generating business and other communications for dispersed users of claim 8, wherein the step of enabling selection of a portion of said content templates and special processing instructions further comprises enabling selection of a portion of said content from said database, a template from said database, a portion of said special processing instructions from said repository, and enabling insertion of said content into said template and generation of a document using said special processing instructions.

12. The method of generating business and other communications for dispersed users of claim 11, wherein said document is stored a memory storage device.

13. The method of generating business and other communications for dispersed users of claim 12, wherein said electronic memory storage device is a readable memory device.

14. The method of generating business and other communications for dispersed users of claim 10, wherein the step of enabling operation of the business communication includes enabling the rendering of said communication at a location including the repository, the marketing agent's workstation, a third party printer, or a customer's workstation.

15. The method of generating business and other communications for dispersed users of claim 14, wherein the step of enabling the rendering of said communication includes at least one of the steps selected from the group consisting essentially enabling printing of the document at a printer operably linked to a computer workstation, displaying the document on a computer monitor operably linked to a computer workstation, or transmitting the document electronically via an electronic mail protocol or facsimile transmission.

16. The method of generating business and other communications for dispersed users of claim 8, wherein the document is a web page and the rendering is performed at least in part by a web browser computer program running on the dispersed user's or customer's workstation.

17. The method of generating business and other communications for dispersed users of claim 14, wherein, after generating the document, the document is stored in hard copy or digital format at the repository, the dispersed user's computer workstation, or at both locations.

18. A method for generating electronic mail, web pages and word processing program formatted business letters for dispersed users, comprising the steps of:
establishing a database of content and templates within a repository, said repository including a micro-processor operably connected to a memory storage device, an input device, an output device, and Local Area Network (LAN), Intranet or Internet of workstations via modem, cable or network link;
inputting into said database content, templates, and, optionally, special processing instructions;
providing access to said database to at least one supervisor, wherein said supervisor reviews and edits the content, templates and special processing instructions stored within said database;
providing remote access to said database to said dispersed users; and
enabling the dispersed user to select a portion of said content from said database, select a template from said database, select special processing instructions, insert said content into said template; and
generate a document.

19. The method of generating business and other communications for dispersed users of claim 18, wherein the document is a web page and the rendering is performed at least in part by a web browser computer program running on the dispersed user's or customer's workstation.

20. The method of generating business and other communications for dispersed users of claim 19, wherein, after generating the document, the document is stored in hard copy or digital format at the repository, the dispersed user's computer workstation, or at both locations.

21. The method of generating business and other communications for dispersed users of claim 18, wherein the step of enabling generating the document includes at least one of the steps selected from the group consisting essentially of enabling printing the document at a printer operably linked to a computer workstation, displaying the document on a computer monitor operably linked to a computer workstation, or transmitting the document electronically via an electronic mail protocol or facsimile transmission.
